(19) United States
(12) Patent Application Publication
(10) Pub. No.: US 2024/0354484 A1
(43) Pub. Date: Oct. 24, 2024

(54) INTEGRATED CIRCUIT DESIGN SYSTEM AND METHOD

(71) Applicant: Foundation for Research and Business, Seoul National University of Science and Technology, Seoul (KR)

(72) Inventors: Jae Won NAM, Seoul (KR); Jin Won HYUN, Seoul (KR)

(73) Assignee: Foundation for Research and Business, Seoul National University of Science and Technology, Seoul (KR)

(21) Appl. No.: 18/537,878

(22) Filed: Dec. 13, 2023

(30) Foreign Application Priority Data
Apr. 21, 2023 (KR) 10-2023-0052650

(51) Int. Cl. G06F 30/398

(52) U.S. Cl. CPC G06F 30/398; G06F 2111/06

(57) ABSTRACT

Disclosed herein are integrated circuit design system and method including: a genetic algorithm model unit configured to form a first parent generation using a performance simulation result for an arbitrary integrated circuit design point, form a child generation from the first parent generation using a genetic algorithm, form a surrounding design point based on the first parent generation as a mutant generation, and then select N points with the highest performance among the first parent generation, the child generation, and the mutant generation as a second parent generation; a comparison unit configured to compare a design range of the second parent generation and a preset reference range; and a regression model unit configured to train a regression model using the design range of the second parent generation when a design range of the second parent generation is narrower than or equal to the preset reference range.

### CROSS-REFERENCE TO RELATED APPLICATION

This application claims the benefit of priority of Korean Patent Application No. 10-2023-0052650, filed on Apr. 21, 2023, the contents of which are incorporated by reference as if fully set forth herein in their entirety.

### FIELD AND BACKGROUND OF THE INVENTION

### 1. Field of the Invention

Embodiments of the present invention relate to an integrated circuit design system and method that can be universally applied to various processes and circuit designs of mixed signal integrated circuits.

### 2. Discussion of Related Art

As semiconductor processes advance, high-performance digital signal circuits can be designed at high operating speeds with significant power reduction. Digital circuit design makes it possible to relatively easily transfer existing circuits to other processes based on a properly configured design automation flow. More specifically, digital circuits can be designed by performing synthesis and layout stages after matching with a standard library through a programming language. This means that the same programming language can be easily migrated to a different unit process as long as a standard library is built.

On the other hand, in analog circuit design, since a structure is different for each functional block that is different from a standard library cell and the performance of a transistor for each process is different, there is a disadvantage in that a designer should redesign an analog circuit in order to migrate to another process. In addition, as the process progresses to a few nanoscales, transistor mismatch has become a bigger problem compared to previous processes, making scaling by a process unit difficult even when the same circuit is designed. Therefore, when a design automation algorithm of an integrated circuit is standardized, there is a growing demand that the design automation algorithm can be easily applied to various circuits and processes to shorten design time.

The characteristics and performance of transistors vary depending on a process unit, and the smaller the unit process, the more severe the transistor mismatch. Since a digital circuit expresses results only in 0 and 1, this is not a big problem, and since an analog circuit expresses results between 0 and 1, there is a problem with accuracy.

Therefore, in order to address such transistor mismatch, a correction method using a capacitor digital-to-analog converter (CDAC), a current digital-to-analog converter (IDAC), or the like is used. However, since changes in voltage and temperature occur even while the circuit is operating, a robust design against process-voltage-temperature (PVT) variations is essential. Therefore, it is important to reduce computer processing time when algorithms for analog circuit automation design are developed, but it is necessary to design algorithms that reflect PVT variations, and thus previous studies have also reflected various design inconsistencies or parasitic components by additionally utilizing a Monte Claro simulation that reflects inconsistency for each transistor or an automated algorithm that automatically arranges a layout of a schematic circuit. However, the above-described method has a disadvantage of increasing computer processing time. Therefore, there is a need to develop an algorithm that reflects PVT variations and requires less computer processing time.

### SUMMARY OF THE INVENTION

The present invention is directed to providing an integrated circuit design system and method capable of performing automation using a high-level program to obtain an accurate design result in optimizing a mixed signal circuit.

According to an aspect of the present invention, there is provided an integrated circuit design system including a genetic algorithm model unit configured to form a first parent generation using a performance simulation result for an arbitrary integrated circuit design point, form a child generation from the first parent generation using a genetic algorithm, form a surrounding design point based on the first parent generation as a mutant generation, and then select N points with the highest performance among the first parent generation, the child generation, and the mutant generation as a second parent generation; a comparison unit configured to compare a design range of the second parent generation and a preset reference range; and a regression model unit configured to train a regression model using the design range of the second parent generation when a design range of the second parent generation is narrower than or equal to the preset reference range.

When the design range of the second parent generation is wider than the preset standard range, the genetic algorithm model unit may re-perform the genetic algorithm forming the second parent generation by including the second parent generation in the first parent generation.

The genetic algorithm model unit may form the child generation from the first parent generation by differentially assigning weight values according to the performance simulation result.

The regression model unit may derive an optimal design point candidate group using a performance simulation result derived by equally dividing the design range of the second parent generation.

The integrated circuit design system may further include a processing configured to select an optimal design point by comparing optimal design point candidate groups derived from a plurality of genetic algorithm model units and a plurality of regression models.

According to another aspect of the present invention, there is provided an integrated circuit design method including forming, by a genetic algorithm model unit, a first parent generation using a performance simulation result and a figure of merit (FOM) value for an arbitrary integrated circuit design point; forming, by the genetic algorithm model unit, a child generation from the first parent generation using a genetic algorithm; forming, by the genetic algorithm model unit, a surrounding design point based on the first parent generation as a mutant generation; selecting, by the genetic algorithm model unit, N points (N is a natural number greater than three) with highest performance among the first parent generation, the child generation, and the mutant generation as a second parent generation; comparing, by a comparison unit, a design range of the second parent generation and a preset reference range; and when a design range of the second parent generation is narrower than or equal to the preset reference range, training, by a regression model unit, a regression model using the design range of the second parent generation.

When the design range of the second parent generation is wider than the preset reference range, the integrated circuit design method may further include re-performing, by the genetic algorithm model unit, the genetic algorithm forming the second parent generation by including the second parent generation in the first parent generation.

In the forming of the child generation, the genetic algorithm model unit may form the child generation from the first parent generation by differentially assigning weight values according to the performance simulation result and the FOM value.

The training of the regression model may include deriving, by the regression model unit, an optimal design point candidate group using a performance simulation result derived by equally dividing the design range of the second parent generation. The integrated circuit design method may further include selecting, by a

processing unit, an optimal design point by comparing optimal design point candidate groups derived from a plurality of genetic algorithm model units and a plurality of regression models.

### BRIEF DESCRIPTION OF THE SEVERAL VIEWS OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a configuration block diagram illustrating an integrated circuit design system according to an embodiment;

FIG. 2 is a conceptual diagram illustrating the integrated circuit design system according to an embodiment;

FIG. 3 is a diagram for describing a regression model unit according to an embodiment;

FIG. 4 is a flowchart for describing the operation of a genetic algorithm model unit according to an embodiment; and

FIG. 5 is a flowchart for describing the operation of the integrated circuit design system according to an embodiment.

### DESCRIPTION OF SPECIFIC EMBODIMENTS OF THE INVENTION

Hereinafter, exemplary embodiments of the present disclosure will be described in detail with reference to the accompanying drawings.

However, the technical idea of the present invention is not limited to some embodiments to be described but may be implemented in various different forms, and as long as it is within the scope of the technical idea of the present invention, one or more among components in the embodiments may be used by being selectively combined and substituted.

Further, unless specifically defined and described, terms used in the embodiments of the present invention (including technical and scientific terms) may be construed as meanings which are generally understood by those skilled in the art to which the present invention pertains, and generally used terms such as terms defined in the dictionary may be interpreted in consideration of the contextual meaning of the related art.

In addition, terms used in the embodiments of the present invention are intended to describe the embodiments and are not intended to limit the present invention.

In the present specification, the singular forms may include the plural forms unless the context clearly dictates otherwise, and, when described as “at least one (or one or more) among A, B, and (or) C,” it may include one or more among all combinations of A, B, and C.

In addition, in describing components of embodiments of the present invention, the terms “first,” “second,” “A,” “B,” “(a),” “(b),” and the like can be used.

These terms are intended to distinguish one component from other components, but the nature and the order or sequence of the components is not limited by these terms.

In addition, when a first component is described as being “linked,” “coupled,” or “connected” to a second component, the first component is not only directly linked, coupled, or connected to the second component, but also “linked,” “coupled,” or “connected” to the second component with a third component disposed between the first component and the second component.

Further, when a component is described as being formed or disposed “on (above) or under (below)” another component, the term “on (above) or under (below)” includes not only cases in which two components are in direct contact with each other, but also cases in which one or more other components are formed or disposed between the two components. Further, when a component is described as being “on (above) or below (under),” the description may include the meanings of an upward direction and a downward direction based on one component.

Hereinafter, embodiments of the present invention will be described in detail with reference to the drawings, the same reference numerals are given to the same or corresponding components regardless of the drawing number, and duplicate descriptions thereof will be omitted herein.

In embodiments, integrated circuit design refers to a process of designing integrated circuits. Typically, an integrated circuit design flow includes multiple stages. For example, clock network synthesis is an example of a stage in the integrated circuit design flow, and during this stage, a clock network is configured to distribute clock signals to sequential circuit elements within the integrated circuit design. Routing is an example of a stage that is performed near the end of the integrated circuit design flow. The routing process may include a disposed netlist, which includes cells with known positions (i.e., disposed cells) and does not include routed wires that electrically interconnect the cells with each other and have multiple inputs not limited to the disposed netlist. The routing process determines wire routes for interconnecting deployed cells with each other and outputs a deployed and routed netlist, and the deployed and routed netlist includes the deployed cells and wire routes for electrically connecting the deployed cells to each other. A number of optimization criteria including, but not limited to, reductions in design rule violations, a via count, a total wire length, and the likelihood of timing violations and the like may be used during the routing process.

A design automation method may be divided into an equation, schematic level simulation, and layout-reflecting simulation. A search algorithm based on schematic level simulation may be applied to an integrated circuit design system according to an embodiment to reduce the operation processing time of a computer.

In embodiments, design parameters refer to any required specifications and/or quantities in integrated circuit design. Variables or features of integrated circuit design include a delay, slack, a slew, a noise margin, a count of logic stages in a combinational logic cloud, an average fanout in the combinational logic cloud, a count of inverters and buffers, a count of cells with correction limits, a count of transition violations, a ratio between a total net delay and a total cell delay, positions of cells, and sizes of cells, but the present invention is not limited thereto. In artificial neural network technology, an input refers to quantities provided as inputs to a learning model (i.e., values that are the basis for performing estimation), and an output refers to quantities produced as outputs by an artificial neural network learning model (i.e., values estimated by a machine learning model) and the input and the output may be performance indicators of various integrated circuits. In the embodiments, the performance of a design point may be a degree to which an amount of design parameters possessed by a specific point on the design circuit is quantified.

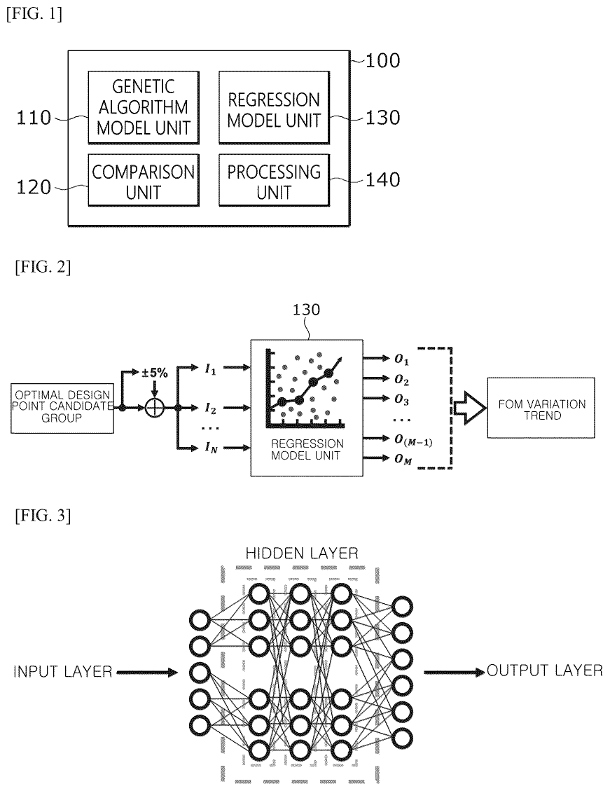

FIG. 1 is a configuration block diagram illustrating an integrated circuit design system according to an embodiment, and FIG. 2 is a conceptual diagram illustrating the integrated circuit design system according to an embodiment. Referring to FIGS. 1 and 2, an integrated circuit design system 100 according to the embodiment may include a genetic algorithm (GA) model unit 110, a comparison unit 120, a regression model unit 130, and a processing unit 140.

The GA model unit 110 may configure a first parent generation using performance simulation results and a figure of merit (FOM) value for an arbitrary integrated circuit design point, configure a child generation from the first parent generation using a GA, configure surrounding design points based on the first parent generation as a mutant generation, and then select N points with the highest performance among the first parent generation, the child generation, and the mutant generation as a second parent generation.

In this case, the GA model unit 110 may configure the child generation from the first parent generation by differentially assigning weight values according to the performance simulation results and the FOM value.

The comparison unit 120 may compare a design range of the second parent generation and a preset reference range.

When the design range of the second parent generation is narrower than or equal to the preset reference range, the comparison unit 120 may transfer the design range of the second parent generation to the regression model.

Alternatively, when the design range of the second parent generation is wider than the preset reference range, the GA model unit 110 may re-perform the GA for forming the second parent generation by including the second parent generation in the first parent generation.

In the embodiments, a design point candidate group of the regression model based on an artificial neural network, which is to be trained through a modified GA, may be selected. In addition, GAs may be run in parallel to select a plurality of design point candidate groups at one time. Initial data of the GA may be run by randomly selecting a position within a specified range. The modified GA proposed in the embodiments may determine the child (next) generation by mainly applying weight values to results with excellent performance on the basis of the results of the parent (current) generation. Basically, the GA is implemented based on three areas by applying a spatial concept, but as necessary, it is also possible to multi-dimensionally implement the GA based on N areas (N is a natural number greater than 3).

In the embodiments, the GA is an algorithm for searching for a solution based on a model of a natural evolution process and is a method of reaching a better solution by expressing possible solutions to a given problem in the form of individuals composed of chromosomes, changing the individuals (selection, crossing, and mutation), and selecting individuals with high fitness among the results and continuing the change.

The GA is an artificial intelligence optimization algorithm based on Darwin's theory of evolution and natural selection and is characterized by survival of the fittest. An environment is set with a fitness function that scores each individual in a random population and an applicable population. The environment then selects individuals who are to become the parents of the next generation through a selection process. The individuals of the next generation (children of the parent of the previous generation) are obtained through a crossover method. As with natural mutation in a gene, an individual of a new generation may be subject to genetic mutation. After a few generations, the gene converges to an individual that represents an optimal solution.

According to the embodiments, there is a random population consisting of an initially specified entire design range, and adaptability to design performance is provided by the fitness function. In an optimization problem, the fitness function is intended to maximize a performance value of a design parameter in a simulation program with integrated circuit emphasis (SPICE) simulation. A plurality of several individual chromosomes are included in each population, which consists of a series of bits which are referred to as genes. In order to reproduce the child generation using the crossover method, several selection methods may be used to select a specific chromosome in each generation. To further mimic biology, there is also the possibility that the chromosome may be subject to mutation. A mutation rate allows an algorithm to deviate from a local minimum value of data. Ultimately, the fittest member of the population survives, and this means that the algorithm converges to an optimal solution.

First, in a step-by-step operation of the genetic algorithm, an initial population of a size p forming the entire design range is randomly selected from a search space. Here, the search space may be a design point with a performance value between the minimum design performance and the maximum design performance.

The randomly selected design point is selected as the parent generation, and the SPICE simulation is performed for evaluating the design performance for each parent generation, that is, what value the random design parameter has.

Then, a selection method is applied by considering each chromosome and its fitness score. In the embodiments, after a parent responsible for the next generation is selected, a weight value is assigned according to the SPICE simulation results of each parent generation. For example, as a SPICE simulation result value for a specific design parameter is high, a high weight value for reproduction is assigned to the corresponding parent generation. In this case, the assigned weight value means that the probability of being selected as a parent causing genetic crossover to generate a child generation may be differentially assigned according to the fitness function. That is, this may mean that the parent generation with high design parameter performance according to the SPICE performance simulation results has a higher probability of being selected as the fittest to form the child generation.

The parent generation to which the weight value is assigned reproduces to obtain the next child generation. In this case, the assigned weight value, the chromosome, and the most suitable individual of the current generation are replicated as part of the next generation. Then, the current generation is updated to the next generation, and the genetic algorithm continues until reaching preset design range criteria. In this case, a mutant generation is generated by assigning a random design parameter value to surrounding points similar to the design point of the parent generation. A mutation operator may be created, for example, by inverting bits according to mutation probability.

Thereafter, the genetic algorithm selects two parents and generates one child. According to the crossover method and the mutation rate used when the child generation is generated, the same parents may generate different children. The newly generated generation is updated with a new child generation obtained through crossover and mutation.

A random, tournament, roulette wheel, or breeder method may be applied as the parent generation selection method of the genetic algorithm.

The random method is the simplest selection method because it does not include selection criteria. This method randomly selects an individual as a parent of the next generation regardless of the fitness function. Due to the quasi-Monte Carlo approach, the algorithm may take a long time to converge.

The tournament method samples k individuals chosen from a population of p and applies the fitness function to the k individuals in order to select the fittest individuals. The K individuals compete against each other in the tournament method to determine the fitness. The fittest individual in each tournament round becomes a parent of the next generation.

The roulette wheel method is a method in which each individual has a selection probability proportional to its fitness. When the fitness of an individual is high, the probability of being selected as a parent is high, and when the fitness of the individual is low, the probability of being selected is low.

The breeder method follows the same strategy used in animal and plant breeding and the goal is to preserve desired traits from the parents of a child. This is achieved by preserving a genetic material from the fittest but still providing some room for mutation by adding several random individuals (a lucky few) to the mix of parents for the next generation.

The genetic algorithm model unit according to the embodiments may be similar to the roulette wheel method in that the genetic algorithm model unit assigns a weight value according to fitness, but the present invention is not necessarily limited thereto, and any method that improves the probability of being selected as the fitness according to the fitness function may be applied.

The crossover method is a breeding method in the genetic algorithm that is characterized by selecting partial characteristics of each parent, which will appear in the child.

In a uniform crossover method, a bit representing a gene is selected from one of the parents with a 50% probability. This method allows the same parents to produce many children with a more diverse set of genes.

Alternatively, k-point crossover may be applied. In the k-point crossover, each parent is divided into k segments. Each segment has an equal probability of being selected to make up a new chromosome for the child. This crossover method may be one-point crossover (k=1) or multi-point crossover (1<k<NC, where NC is a length of the chromosome). In the one-point crossover, only two different children may be generated.

One cycle of the genetic algorithm may consist of a parent generation, a child generation, and a mutant generation. A plurality of design points with the highest fitness function among all the generations configured during one cycle are designated as the next parent generation. In the embodiments, three design points are designated as the next parent generation, but the number of design points forming the next parent generation may be changed according to various factors such as design purpose and design environment.

When an area surrounded by the design points designated as the next parent generation is a design range, the comparison unit 120 compares the design range with the preset reference range. When a width of the design range is narrower than or equal to a width of the preset reference range, the comparison unit 120 transfers the design points selected as the next parent generation to the regression model unit to derive optimal design points.

On the other hand, when the width of the design range is wider than the width of the preset reference range, the next parent generation forms a parent generation together with the previous parent generation, and the above-described genetic algorithm is performed again.

That is, the integrated circuit design system according to the embodiments may derive the design point with the highest fitness function among the design points distributed in the entire area through the genetic algorithm. In this process, when the design range formed through a connection between the selected design points is derived more narrowly and specifically than the reference range, the corresponding design points are transferred to the regression model unit to calculate the optimal design point.

On the other hand, when the design range formed through the connection between the selected design points is derived wider than the reference range, a computational load of the regression model unit may be reduced by repeatedly performing the genetic algorithm to narrow the range of an optimal design point candidate group.

When a design range of the second parent generation is narrower than or equal to the preset reference range, the regression model unit 130 may train the regression model using the design range of the second parent generation.

The regression model unit 130 may derive an optimal design point candidate group using performance simulation results derived by equally dividing the design range of the second parent generation.

Based on the design range derived through the GA model unit 110, an optimized point may be found by learning the genetic algorithm and an artificial neural network-based regression model developed using simulation data. The genetic algorithm allows for accurate design in a desired direction as generations pass, but the genetic algorithm has a disadvantage of taking a long time. Therefore, when the design range is reduced to an appropriate range through the genetic algorithm, a design method through the artificial neural network-based regression model may be more accurate.

In the embodiments, the regression model unit 130 may include a processing unit and a learning model.

The learning model consists of an input layer, an output layer, and a hidden layer, and the optimal number and sizes of hidden layers may vary according to data and a circuit. In addition, the size of each different hidden layer is not the same and is adjustable.

The processing unit 140 may divide design parameters according to preset criteria. The processing unit 140 may equally divide design parameters according to preset values.

The processing unit 140 may divide design parameters corresponding to the design range input for learning. The division method may randomly or equally divide sections. In the embodiments, the processing unit 140 may equally divide design parameters into sections according to preset values. In the case of random division, the division may be biased, and in most cases, may result in the accuracy of the regression model for an opposite side being very small because the simulation results are not linear. In the embodiments, since an approximate position of the largest FOM should be determined through small-scale simulation, an equal division method may be applied.

A learning model unit may learn the divided design parameters to derive an optimal design point candidate group.

The learning model unit may include an input layer for receiving the divided design parameters, a hidden layer for encoding the received design parameters, and an output layer for decoding and outputting an encoded result to which Gaussian noise is added.

In the embodiments, the learning model unit may estimate all results falling within the design range. The learning model unit may compare the results estimated through the hidden layer and select a plurality of best optimal design point candidate groups.

In the embodiments, the regression model is trained using simulation data to find optimized points. The simulation data may consist of results regarding specific points which are discretely divided within the overall range. Obtaining detailed results over the entire range is not critical, but design time increases indefinitely. Therefore, in the embodiments, the optimized points are calculated using a regression model that estimates the simulation results for the detailed design points. In addition, since an amount of data to be trained in the regression model is small, an artificial neural network (ANN) model is applied instead of deep learning models such as a recurrent neural network, a convolutional neural network, and a deep neural network.

FIG. 3 is a diagram for describing the regression model unit 130 according to the embodiments. Referring to FIG. 3, an input of the regression model unit 130 may be a design parameter, and an output thereof may be essential design specifications. The hidden layer consists of three layers, and a size of one hidden layer may be changed according to an amount of data to be trained. The number of layers may also be variably selected according to the amount of data, and unrelated input data may be divided and input into a first hidden layer according to the division result in the processing unit 140. As shown in FIG. 3, a connection of the first hidden layer in the ANN regression model may be divided based on data series. This may work on a similar principle to providing a kind of learning guide when the model is trained. Therefore, a designer may train the ANN regression model more efficiently and accurately by dividing the input data in a desired direction.

The input layer and the hidden layer of the learning model unit may be composed of an encoder. The encoder may also be a recognition network and may transform an input into an internal representation.

The output layer of the learning model unit may be composed of a decoder. The decoder may also be a generative network and may transform the internal representation into an output.

First, multidimensional data input into the input layer enters the hidden layer. An output of the hidden layer may be the encoded result, the encoded result output from the hidden layer enters the output layer, the encoding process and the decoding process occur continuously in the model, and the number of hidden layers may be higher than one.

The processing unit 140 may select an optimal design point by comparing optimal design point candidate groups derived from a plurality of GA model units 110 and a plurality of regression models.

Generally, when an analog circuit is designed, the design point, which is suitable for the desired performance and has the best FOM configured by the designer, is selected as the optimal design point. However, as process technology develops, transistor mismatch increases, and thus the importance of considering not only FOM but also changes in transistors and changes according to temperature and voltage is increasing. Therefore, when design is performed only using an artificial neural network-based regression model and N variables for an environmental change are needed, since an amount of data required for training is N times greater, a computational burden may increase. However, the genetic algorithm, which goes through generations with less data than the regression model, may solve such a problem.

In order to derive an FOM variation trend based on the trained regression model, the processing unit 140 may generate an input on the basis of a 5% error for the optimal design point candidate group and, on the basis of the output from the regression model, it is possible to estimate how large the change will be based on the FOM in the optimal design point candidate group. In deriving the FOM variation trend, when the accuracy of the regression model is low, errors are added to a value for the FOM variation, making the FOM variation value unreliable but, when the regression model has high accuracy, the FOM variation for the change in design parameter may also be determined to be reliable as a variation value.

That is, the processing unit 140 may derive a design point with the highest FOM performance and the smallest PVT variation among the plurality of optimal design point candidate groups as the optimal design point.

For example, the processing unit 140 may vary design variables of each optimal design point candidate group by 5% and then simulate SS and FF conditions for each corner, thereby deriving a point with the smallest change in FOM results as the optimal design point. In this case, each mismatch factor may be additionally applied for an accurate PVT variation estimation. Therefore, the mismatch factor may be corrected at the derived optimal design point, and then an additional simulation such as a Monte Carlo simulation may be performed.

In this way, the processing unit 140 may select the optimal design point from the optimal design point candidate group. In this case, the processing unit 140 may select an optimal design point by comparing optimal design point candidate groups derived from the plurality of GA model units 110 and the plurality of regression models, which are executed in parallel.

In an initialization state, the plurality of genetic algorithm model units and the plurality of regression models each perform a process of calculating the optimal design point candidate group based on different design points and different design ranges. In this case, since the design point and the design range are selected randomly, the time for calculating the optimal design point candidate group may vary according to a distance between the design point where the genetic algorithm is initially performed and an actual optimal design point. For example, when the design point where the genetic algorithm is initially performed and the actual optimal design point are far away or close together, there may be a significant difference in the time for calculating the optimal design point candidate group. To this end, the integrated circuit design system according to the embodiments may perform an operation of calculating the optimal design point candidate group in parallel using the plurality of genetic algorithm model units and the plurality of regression model units, and in this way, the time for calculating the optimal design point candidate group can be shortened.

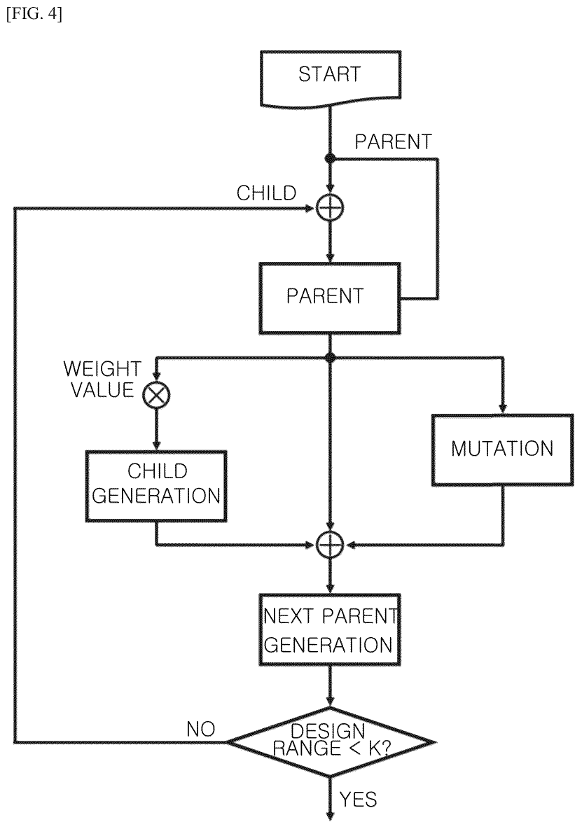

FIG. 4 is a flowchart for describing the operation of the genetic algorithm model unit according to the embodiments.

The genetic algorithm model unit derives the performance results of design points at random positions within the overall design range initially specified through SPICE simulation. Next, the genetic algorithm model unit generates children by assigning high weight values to parents with high FOMs along with the SPICE simulation results. Simultaneously, random variables are applied to additionally generate mutations around the parents. The mutations around the parents may refer to points similar to design points of the parents.

The genetic algorithm model unit specifies three design points with the highest performance simulation results on the basis of all generated data as the next parent generation. When a range of the three design points, which is the next parent generation, is smaller than a preset range K, a design range is transferred to the regression model unit, and otherwise, the genetic algorithm is applied again on the basis of the next parent generation. Data for the parents may be calculated by including data for previous parents. In addition, for robust design against PVT variations, results may include a corner simulation for SPICE results and a simulations for parameter variations.

For example, the processing unit may select n candidate design points (n is a natural number) with the highest FOM performance among the optimal design point candidate groups, evaluate a PVT deviation through the corner simulation of the selected n candidate design points, and derive the optimal design point.

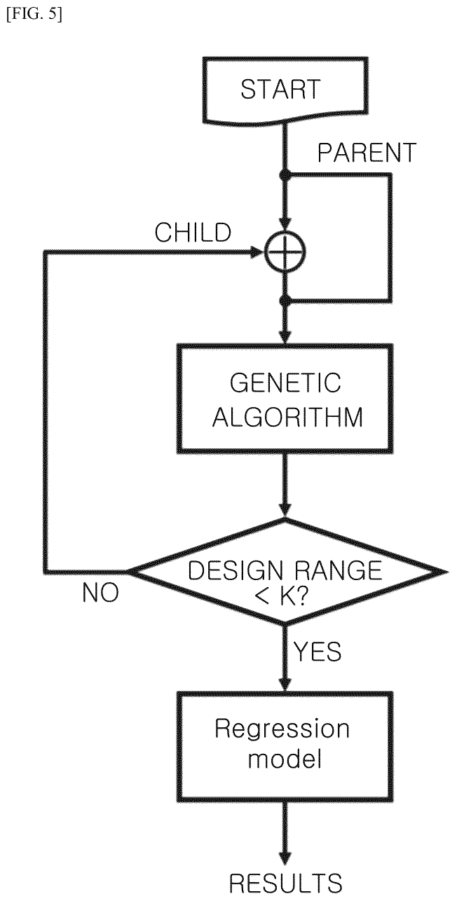

FIG. 5 is a flowchart for describing the operation of the integrated circuit design system according to the embodiments.

Referring to FIG. 5, when the design range of the child generation is reduced to an appropriate range, the regression model unit finds the optimal design point candidate group using the artificial neural network-based learning model. In addition, the processing unit derives the best optimal design point using all the derived optimal design point candidate groups derived in parallel through the genetic algorithm model unit and the regression model unit. This is to prevent the genetic algorithm from reaching a local optimal value due to random variables and failing to reach a global optimal value or prevent an increase in the application time of the genetic algorithm that is far different from the global optimal value.

The integrated circuit design system according to the embodiments may derive an optimal value based on SPICE simulation data derived by equally dividing the design parameters based on the range derived through the genetic algorithm. When the regression model is trained in a sufficiently small range through the genetic algorithm, the accuracy of the regression model can increase, and thus the accuracy of FOM variations due to design parameter variations can be improved. In addition, when the design parameters are equally divided and results for voltage and temperature are additionally trained, FOM variations for PVT variations may also be confirmed. Consequently, by applying N algorithms simultaneously and comparing N final results, an optimal point with a high FOM and the smallest PVT variation may be derived as the design point.

The integrated circuit design system according to the embodiments may reduce operations required for optimized design by applying a weight value through a modified genetic algorithm. In addition, in order to compensate for a reduction in design time efficiency when the optimization operation is set for a long period of time, which is a disadvantage of the genetic algorithm, by applying the artificial neural network-based regression model, there is a technical effect of overcoming the disadvantage of a long design time and implementing accurate design. In addition, since PVT variations may be compared at one time using the high accuracy of the regression model in a narrow range, time costs for design can be significantly reduced.

In addition, through the embodiments, time costs required for designing a mixed-signal integrated circuit can be drastically reduced. In addition, results from various aspects of a given circuit can be quantitatively optimized simultaneously and multiple comparison groups can be analyzed simultaneously. Therefore, through random initial design settings, it is possible to quickly design an optimized circuit with excellent performance even when a circuit designer is not an experienced circuit designer. In addition, when it falls within an appropriate range, an artificial neural network-based regression model allows for faster and more accurate design is possible than design applying only a genetic algorithm or an algorithm using a regression model.

The term “unit” used in the embodiments refers to software or hardware components such as a field programmable gate array (FPGA) or an application specific integrated circuit (ASIC) and performs predetermined roles. However, “unit” is not a meaning limited to software or hardware. The “unit” may be configured to reside in an addressable storage medium or to reproduce one or more processors. Thus, as an example, “unit” includes components such as software components, object-oriented software components, class components, and task components, and processes, functions, attributes, procedures, sub-routines, segments of program code, drivers, firmware, microcode, circuits, data, databases, data structures, tables, arrays, and variables. The functions provided in the components and “units” may be combined into a smaller number of components and “units” or may be further divided into additional components and “units.” In addition, the components and “units” may be implemented to reproduce one or more central processing units (CPUs) in a device or a secure multimedia card.

An integrated circuit design system and method according to embodiments can improve efficiency in terms of time and cost compared to the existing automated integrated circuit design.

In addition, for integrated circuit design, an integrated circuit with excellent performance can be designed by reflecting process-voltage-temperature (PVT) variations.

Although the description has been made with reference to exemplary embodiments of the present invention, it should be understood that various changes and modifications of the present invention can be devised by those skilled in the art to which the present invention pertains without departing from the spirit and scope of the present invention, which are defined by the appended claims.

What is claimed is:

1. An integrated circuit design system comprising:
a genetic algorithm model unit configured to form a first parent generation using a performance simulation result and a figure of merit (FOM) value for an arbitrary integrated circuit design point, form a child generation from the first parent generation using a genetic algorithm, form a surrounding design point based on the first parent generation as a mutant generation, and then select N points (N is a natural number greater than three) with highest performance among the first parent generation, the child generation, and the mutant generation as a second parent generation;
a comparison unit configured to compare a design range of the second parent generation and a preset reference range; and
a regression model unit configured to train a regression model using the design range of the second parent generation when a design range of the second parent generation is narrower than or equal to the preset reference range.

2. The integrated circuit design system of claim 1, wherein, when the design range of the second parent generation is wider than the preset reference range, the genetic algorithm model unit re-performs the genetic algorithm forming the second parent generation by including the second parent generation in the first parent generation.

3. The integrated circuit design system of claim 2, wherein the genetic algorithm model unit forms the child generation from the first parent generation by differentially assigning weight values according to the performance simulation result and the FOM value.

4. The integrated circuit design system of claim 1, wherein the regression model unit derives an optimal design point candidate group using a performance simulation result derived by equally dividing the design range of the second parent generation.

5. The integrated circuit design system of claim 4, further comprising a processing unit configured to select an optimal design point by comparing optimal design point candidate groups derived from a plurality of genetic algorithm model units and a plurality of regression models.

6. An integrated circuit design method comprising:
forming, by a genetic algorithm model unit, a first parent generation using a performance simulation result and a figure of merit (FOM) value for an arbitrary integrated circuit design point;
forming, by the genetic algorithm model unit, a child generation from the first parent generation using a genetic algorithm;
forming, by the genetic algorithm model unit, a surrounding design point based on the first parent generation as a mutant generation;
selecting, by the genetic algorithm model unit, N points (N is a natural number greater than three) with highest performance among the first parent generation, the child generation, and the mutant generation as a second parent generation;
comparing, by a comparison unit, a design range of the second parent generation and a preset reference range; and
when a design range of the second parent generation is narrower than or equal to the preset reference range, training, by a regression model unit, a regression model using the design range of the second parent generation.

7. The integrated circuit design method of claim 6, further comprising, when the design range of the second parent generation is wider than the preset reference range, re-performing, by the genetic algorithm model unit, the genetic algorithm forming the second parent generation by including the second parent generation in the first parent generation.

8. The integrated circuit design method of claim 7, wherein, in the forming of the child generation, the genetic algorithm model unit forms the child generation from the first parent generation by differentially assigning weight values according to the performance simulation result and the FOM value.

9. The integrated circuit design method of claim 6, wherein the training of the regression model includes deriving, by the regression model unit, an optimal design point candidate group using a performance simulation result derived by equally dividing the design range of the second parent generation.

10. The integrated circuit design method of claim 9, further comprising selecting, by a processing unit, an optimal design point by comparing optimal design point candidate groups derived from a plurality of genetic algorithm model units and a plurality of regression models.
